(19) United States
(12) Patent Application Publication
(10) Pub. No.: US 2010/0308899 A1
(43) Pub. Date: Dec. 9, 2010

(54) Dual-Output Triple-Vdd Charge Pump

(75) Inventor: Anthony Yap Wong, Cupertino, CA (US)

Correspondence Address: STUART T AUVINEN, 429 26TH AVENUE, SANTA CRUZ, CA, 95062-5319, US

(73) Assignee: PERICOM SEMICONDUCTOR CORP., San Jose, CA (US)

(21) Appl. No.: 12/478,674

(22) Filed: Jun. 4, 2009

(51) Int. Cl. G05F 1/10

(52) U.S. Cl. 327/536

(57) ABSTRACT

A dual-output triple-Vdd charge pump as two pumped outputs that are both pumped to three times the power-supply voltage, 3×Vdd. This pumped output voltage is reduced by two p-channel inner diode drops, to 3×Vdd−2×|Vtp|. A pair of cross-coupled n-channel transistors alternately charge two inner nodes from the power supply. Inner pumping capacitors drive inner nodes between Vdd and 2×Vdd, and the cross-coupling of the gates turns off one of the cross-coupled n-channel transistors when its inner node is being driven high. A p-channel inner diode transistor connects an inner node to an outer node, causing a |Vtp| drop. The outer node is also pumped by an outer pumping capacitor that drives the outer node between 2×Vdd−|Vtp| and 3×Vdd−|Vtp|. A p-channel outer diode transistor conducts from the outer node to the pumped output node, causing another |Vtp| voltage drop. The pumped output voltage is maintained at 3×Vdd−2×|Vtp| by an output capacitor.

### FIELD OF THE INVENTION

This invention relates to transistor circuits, and more particularly to charge pumps.

### BACKGROUND OF THE INVENTION

Charge pumps are widely used in a variety of semiconductor chips. Charge pumps are used to boost voltages of word or row lines in memory chips, allowing for a greater drive voltage and faster sensing speeds. Charge pumps are used to generate negative voltages below ground for substrate biasing. Charge pumps are also used to boost gate voltages of large bus-switch transistors, allowing a smaller transistor size to be used to drive a large load.

As power-supply voltages are reduced as device sizes shrink, the lower voltage drive on transistors reduces performance. Boosting voltages is one way to compensate for this device-shrink problem. Sometimes a single charge pump stage is insufficient to reach a desired boosted voltage. Several cascaded stages of charge pumps may then be used. Boosted voltages that are several multiples above the power supply voltage (Vdd or Vcc) may be desired.

FIG. 1 shows a prior-art charge pump that pumps to 4 times Vdd. A clock CLK is buffered by inverters 20, 22, driving CK2, CK1 between ground and Vdd. The left plates of pumping capacitors 12, 14, 16 are driven between ground and Vdd. When CK1 is low, diode 24 charges the other plate of pumping capacitor 12 to Vdd. As CK1 rises, diode 24 shuts off, allowing capacitive coupling through pumping capacitor 12 to raise the voltage between diodes 24, 26. When CK1 reaches Vdd, this voltage on the right plate of pumping capacitor 12 reaches a theoretical maximum of 2×Vdd.

A similar pumping action by CK2 on pumping capacitor 14 causes the right plate of pumping capacitor 14 to pump between 2×Vdd and 3×Vdd. When CK1 is Vdd and CK2 is ground, diode 26 conducts, conducting the 2×Vdd from pumping capacitor 12 to pumping capacitor 14. Then as CK2 rises from ground to Vdd, this voltage on the right plate of pumping capacitor 14 swings from 2×Vdd to 3×Vdd.

A similar pumping action by CK1 on pumping capacitor 16 causes the right plate of pumping capacitor 16 to pump between 3×Vdd and 4×Vdd. When CK2 is Vdd and CK1 is ground, diode 28 conducts, conducting the 3×Vdd from pumping capacitor 14 to pumping capacitor 16. Then as CK1 rises from ground to Vdd, this voltage on the right plate of pumping capacitor 16 swings from 3×Vdd to 4×Vdd.

Output diode 30 allows load capacitor 18 to be charged when the right plate of pumping capacitor 16 is above the output pumped voltage Vp. Vp is charged up to 4×Vdd.

Real-world effects reduce the pumped voltage Vp. For example, capacitor coupling ratios reduce the pumped voltage at each stage in the charge pump. The voltage on the right plate of pumping capacitor 12 is reduced by the ratio of the capacitance of pumping capacitor 12 to the sum or parasitic capacitances on the node connected to the right plate of pumping capacitor 12, which includes diodes 24, 26 and any wiring capacitances. The voltages on the right plates of pumping capacitors 14, 16 are similarly reduced by coupling ratios at each node. Finally, load capacitor 18 may be so large that the pumping current through diode 30 is unable to fully pump up Vp. Current may also leak out from Vp, such as from transistors into bulk or substrate nodes. The final pumped voltage Vp is usually much less than the theoretical maximum of 4×Vdd.

Sense circuit 10 can receive pumped voltage Vp and compare it to a target voltage, and then shut off oscillator 15 when Vp is above the target voltage. Clock CLK is generated by oscillator 15; thus charge pumping is disabled by sense circuit 10.

FIG. 2 shows a prior art multi-stage charge pump implemented with n-channel transistors. Diodes 24, 26, 28, 30 of FIG. 1 are implemented as n-channel transistors 32, 34, 36, 38 in FIG. 2. Each transistor has its gate and drain connected together, allowing current to flow as long as the source voltage is one threshold voltage (Vt) below the drain/gate voltage. However, this threshold voltage Vt is larger than the nominal Vtn since the source is above ground due to the body effect. Each of transistors 32, 34, 36, 38 can have a drop of about 1 volt, so pumped voltage Vp is reduced by about 4 volts, to 4×Vdd−4×Vt.

While useful, such multi-stage charge pumps suffer from diode voltage drops using n-channel transistors for the diodes. The transistor thresholds are also increased due to the body effect. Capacitor coupling ratios are difficult to maintain unless huge pumping capacitors are used relative to parasitic capacitances. This increases area and expense.

What is desired is a charge pump circuit that uses p-channel transistors rather than n-channel transistors for at least some of the diodes. A charge pump that can pumps to several multiples of Vdd is desired. A charge pump that can be implemented in a standard complementary metal-oxide-semiconductor (CMOS) process and integrated with other circuits on a semiconductor chip is desirable. A charge pump with multiple outputs is also desired.

### BRIEF DESCRIPTION OF THE DRAWINGS

FIG. 1 shows a prior-art charge pump that pumps to 4 times Vdd.

FIG. 2 shows a prior art multi-stage charge pump implemented with n-channel transistors.

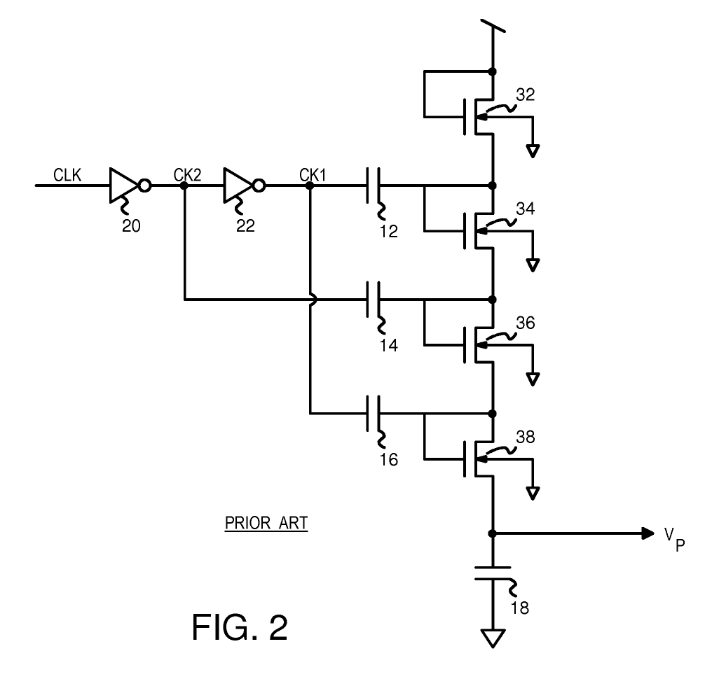

FIG. 3 is a schematic diagram of a dual-output triple-Vdd charge pump.

FIG. 4 is a functional diagram of the dual-output triple-Vdd charge pump.

FIG. 5 is a timing diagram of operation of the dual-output triple-Vdd charge pump of FIG. 3.

FIG. 6 is a graph of the transient response of the dual-output triple-Vdd charge pump of FIG. 3.

### DETAILED DESCRIPTION

The present invention relates to an improvement in charge pump circuits. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

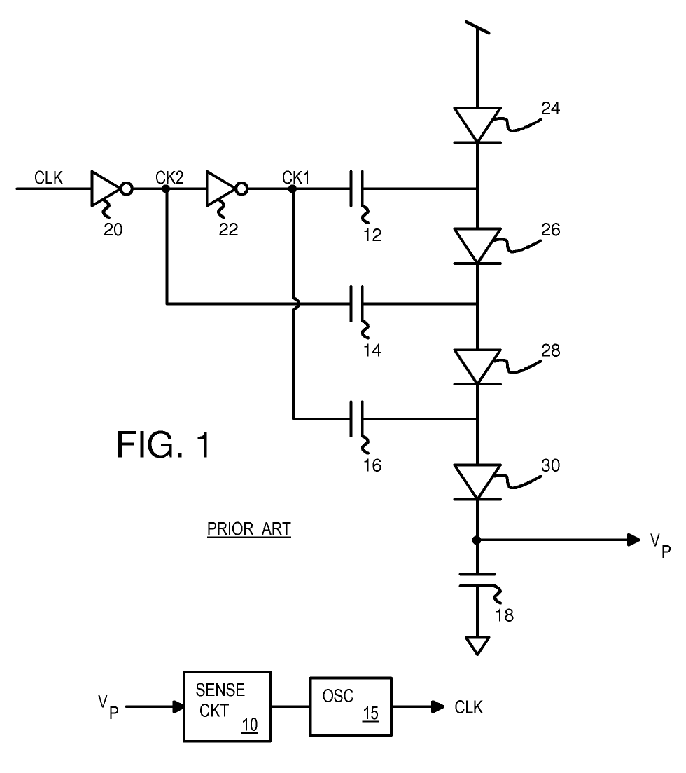

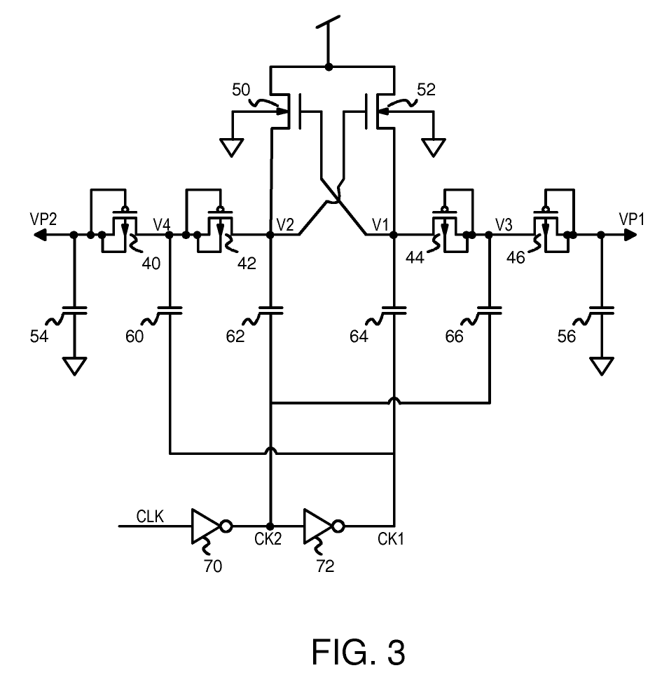

FIG. 3 is a schematic diagram of a dual-output triple-Vdd charge pump. A clock CLK drives inverters 70, 72 which drive CK2, CK1 between Vdd and ground. CLK may be disabled by a sense circuit and oscillator as shown in FIG. 1 by comparing either pumped output voltage VP1 or VP2 to a target voltage. The target voltage may be generated by a band-gap voltage generator or other reference circuit, or may be an external input.

CK1 and CK2 pump on pumping capacitors 64, 62, respectively, swinging their bottom plates between ground and Vdd. The top plates of pumping capacitors 64, 62 are nodes V1, V2, respectively, which receive power-supply current through cross-coupled n-channel transistors 52, 50, respectively. The gate of cross-coupled n-channel transistor 50 is node V1 while its source is node V2. The gate of cross-coupled n-channel transistor 52 is node V2 while its source is node V1. The drains of cross-coupled n-channel transistors 50, 52 is power supply Vdd while their bulk or substrate nodes are grounded.

Nodes V1, V2 are pumped to 2×Vdd by pumping capacitors 62, 64. Since the gates of cross-coupled n-channel transistors 52, 50 are at the higher pumped voltages V1, V2, these transistors do not have the threshold voltage Vt drop. Cross-coupled n-channel transistors 52, 50 toggle on and off during pumping due to the cross-coupled gate connection to prevent back-flow to Vdd from nodes V1, V2.

P-channel inner diode transistor 44 has its gate and bulk nodes connected to node V3, allowing current to flow from its source node V1 when V1 is more than |Vtp| above its drain, node V3. Otherwise back-current flow is blocked by p-channel inner diode transistor 44. Outer pumping capacitor 66 pumps node V3 higher by an additional Vdd swing.

When CK2 is low, cross-coupled n-channel transistor 52 is off and p-channel inner diode transistor 44 turns on to drive current to node V3 at 2×Vdd−Vtp. When CK2 goes high, cross-coupled n-channel transistor 52 is on and p-channel inner diode transistor 44 turns off, allowing outer pumping capacitor 66 to pump node V3 to 3×Vdd−Vtp.

P-channel outer diode transistor 46 has its gate and bulk nodes connected to first pumped output node VP1, allowing current to flow from its source node V3 to charge first load capacitor 56 when V3 is more than |Vtp| above its drain, node VP1. Otherwise back-current flow is blocked by p-channel outer diode transistor 46. There is a voltage drop of |Vtp| through each of p-channel inner diode transistor 44 and p-channel outer diode transistor 46, so the voltage of first output pumped voltage VP1 is limited to 3×Vdd−2×|Vtp|.

A second output pumped voltage VP2 on load capacitor 54 is also generated from node V2. P-channel inner diode transistor 42, p-channel outer diode transistor 40, and outer pumping capacitor 60 operate in a similar manner as described for transistors 44, 46 and capacitor 66, using CK1 rather than CK2. The voltage of second output pumped voltage VP2 is also limited to 3×Vdd−2×|Vtp|.

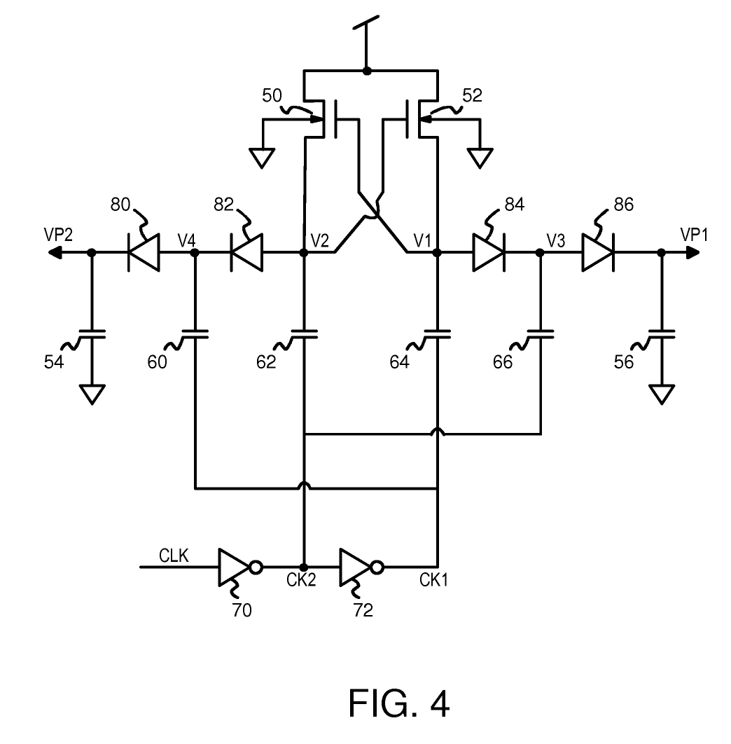

FIG. 4 is a functional diagram of the dual-output triple-Vdd charge pump. P-channel inner diode transistors 42, 44, and p-channel outer diode transistors 40, 46 are replaced with diodes 82, 84 and 80, 86, respectively. These diodes prevent back-current flow. The actual p-channel transistors have a |Vtp| voltage drop compared with an idealized diode, which reduces the output pumped voltages.

When CK1 goes high and CK2 goes low, inner pumping capacitor 64 drives node V1 higher while inner pumping capacitor 62 drives node V2 lower. The higher V1 applied to the gate turns on cross-coupled n-channel transistor 50 while the lower V2 turns off cross-coupled n-channel transistor 52. Node V1 is isolated from power supply Vdd by cross-coupled n-channel transistor 52, allowing inner pumping capacitor 64 to further raise the voltage of V1. The higher voltage V1 turns on diode 84, allowing current to flow from node V1 to node V3, raising the voltage of node V3. At the same time, the lower CK2 applied to outer pumping capacitor 66 fully charges outer pumping capacitor 66 through diode 84.

Diode 82 is off since node V4 is higher than node V2 as V2 goes lower with CK2 going lower. However, current from Vdd passes into node V2 to charge the top plate of inner pumping capacitor 62 through cross-coupled n-channel transistor 50 which is turned on.

When CK2 goes high and CK1 goes low, inner pumping capacitor 62 drives node V2 higher while inner pumping capacitor 64 drives node V1 lower. The higher V2 applied to the gate turns on cross-coupled n-channel transistor 52 while the lower V1 turns off cross-coupled n-channel transistor 50. Node V2 is isolated from power supply Vdd by cross-coupled n-channel transistor 50, allowing inner pumping capacitor 62 to further raise the voltage of V2. The higher voltage V2 turns on diode 82, allowing current to flow from node V2 to node V4, raising the voltage of node V4. At the same time, the lower CK1 applied to outer pumping capacitor 60 fully charges outer pumping capacitor 60 through diode 82.

Diode 84 is off since node V3 is higher than node V1 as V1 goes lower with CK1 going lower. However, current from Vdd passes into node V1 to charge the top plate of inner pumping capacitor 64 through cross-coupled n-channel transistor 52 which is turned on.

When V3 is higher than VP1, output diode 86 turns on to charge first load capacitor 56, which maintains first output pumped voltage VP1. Likewise, When V4 is higher than VP2, output diode 80 turns on to charge second load capacitor 54, which maintains second output pumped voltage VP2.

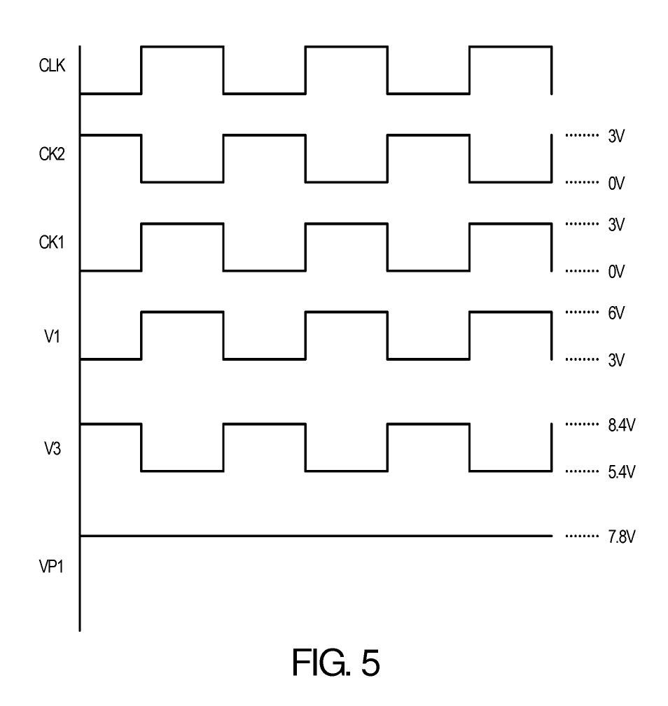

FIG. 5 is a timing diagram of operation of the dual-output triple-Vdd charge pump of FIG. 3. In this example the power-supply voltage Vdd is 3 volts. When CLK pulses high, CK2 pulses low to ground and CK1 pulses high to 3 volts. When CLK pulses low, CK1 pulses low to ground and CK2 pulses high to 3 volts.

Inner node V1 is charged to 3 volts during the down stroke of CK1 when cross-coupled n-channel transistor 52 is on, and is pumped by inner pumping capacitor 64 to 6 volts (2×Vdd) by the up stroke of CK1 when cross-coupled n-channel transistor 52 is turned off by the down stroke of CK2.

When V1 is high, p-channel inner diode transistor 44 turns on, driving outer node V3 to 2×Vdd−|Vtp| or about 5.4 volts. Then as CK2 rises, p-channel inner diode transistor 44 turns off and outer pumping capacitor 66 drives outer node V3 up by an additional swing of Vdd, to 3×Vdd−|Vtp| or about 8.4 volts when Vtp is about 0.6 volt.

First output pumped node VP1 is charged to one p-channel inner diode threshold less than the maximum of outer node V3, or to 3×Vdd−2×|Vtp| or about 7.8 volts.

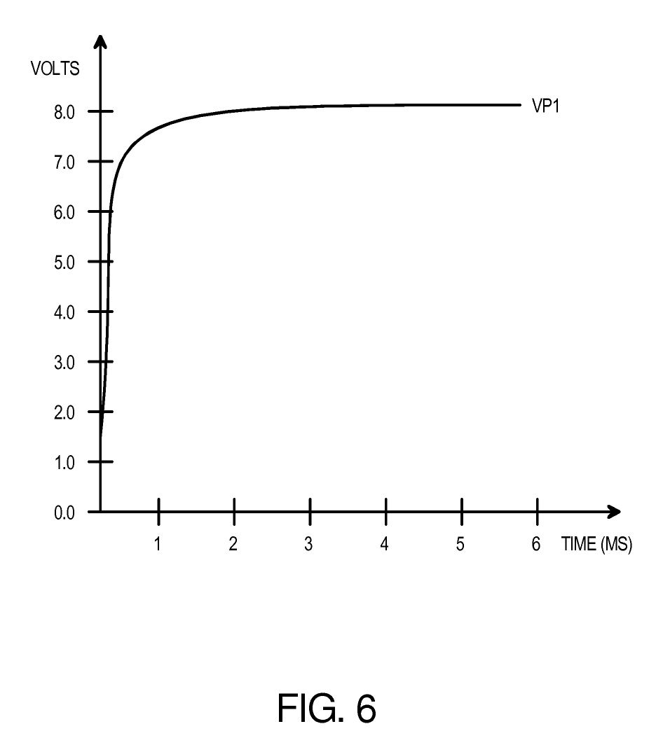

FIG. 6 is a graph of the transient response of the dual-output triple-Vdd charge pump of FIG. 3. When the oscillator turns on to pulse CLK, the first output pumped node VP1 is gradually charged until it reaches its maximum of about 7.8 volts. This value is reached within about 1 millisecond.

### Alternate Embodiments

Several other embodiments are contemplated by the inventor. For example. Load capacitors may represent parasitic capacitances on an output node, such as an n-channel gate to drain/source and substrate capacitances of downstream transistors and wiring capacitances. An actual load capacitor may not be present. Careful design and layout should be used to control capacitive coupling ratios and the efficiency of the actual circuit. Wiring lengths can be kept to a minimum and the sizes of pumping capacitors kept larger than parasitic capacitances. The charging capacitor may be replaced by an n-channel gate to drain/source parasitic capacitor or a p-channel gate to drain/source and body parasitic capacitor.

The charge pump may be disabled to save power, such as during power-down modes, or when a sense circuit determines that a target output voltage has been reached. Various filters may be added to smooth responses. |Vtp| is the absolute value of the p-channel inner diode threshold voltage, which can vary with process and other conditions. Sometimes the threshold may be referred to without mention of the absolute value which is understood. The bulk or body bias voltage may also change this threshold voltage. Capacitors could include several capacitors in parallel rather than be a single capacitor. Likewise, transistors may have several legs or segments connected together.

The charge pump can be connected to Vdd or to any fixed voltage which is generated by an internal voltage regulator circuit. Transistor device sizes can be adjusted. Buffers and inversions can be added or removed. Additional levels of boosting could be added to boost to four, five, or more times Vcc. The VP1 and/or VP2 voltage can be adjusted to match the target boost voltage, or VP1 or VP2 can be some other elevated voltage that does not exactly match the boost voltage. Some conduction through keeper transistors could then occur. The boosted output voltages VP1 and VP2 could be different voltages. The clocks could be exact inverses or could have delays. Clocks may be buffered, inverted, or divided into segments in a variety of ways and yet be the same clock.

The terms source and drain are interchangeable. The relative voltages on source/drain nodes determine which is considered to be the source and which is considered to be the drain at any instant in time. As voltages change, a particular node may go from acting as a source to acting as a drain.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A dual-output triple-Vdd charge pump comprising:
a first cross-coupled transistor having a first gate connected to a first inner node for conducting current from a power supply to a second inner node;
a second cross-coupled transistor having a second gate connected to the second inner node for conducting current from the power supply to the first inner node;
a first inner pumping capacitor coupled to the first inner node, being driven by a first clock;
a second inner pumping capacitor coupled to the second inner node, being driven by a second clock;
a first inner diode coupled to conduct current between the first inner node and a first outer node, and for preventing back current flow from the first outer node to the first inner node;
a first outer pumping capacitor coupled to the first outer node, being driven by the second clock; and
a first outer diode coupled to conduct current between the first outer node and a first output node, and for preventing back current flow from the first output node to the first outer node.

2. The dual-output triple-Vdd charge pump of claim 1 further comprising:
a second inner diode coupled to conduct current between the second inner node and a second outer node, and for preventing back current flow from the second outer node to the second inner node;
a second outer pumping capacitor coupled to the second outer node, being driven by the first clock; and
a second outer diode coupled to conduct current between the second outer node and a second output node, and for preventing back current flow from the second output node to the second outer node,
whereby two outputs are generated.

3. The dual-output triple-Vdd charge pump of claim 2 wherein the first cross-coupled transistor is an n-channel transistor;
wherein the second cross-coupled transistor is an n-channel transistor.

4. The dual-output triple-Vdd charge pump of claim 3 wherein a bulk node of the first cross-coupled transistor is grounded;
wherein a bulk node of the second cross-coupled transistor is grounded.

5. The dual-output triple-Vdd charge pump of claim 4 wherein the first inner diode is a p-channel transistor having a gate connected to the first outer node;
wherein the second inner diode is a p-channel transistor having a gate connected to the second outer node;
wherein the first outer diode is a p-channel transistor having a gate connected to the first output node;
wherein the second outer diode is a p-channel transistor having a gate connected to the second output node.

6. The dual-output triple-Vdd charge pump of claim 5 wherein a substrate of the first inner diode is connected to the first outer node;
wherein a substrate of the second inner diode is connected to the second outer node.

7. The dual-output triple-Vdd charge pump of claim 6 wherein a substrate of the first outer diode is connected to the first output node;
wherein a substrate of the second outer diode is connected to the second output node.

8. The dual-output triple-Vdd charge pump of claim 2 wherein the first clock and the second clock are inverses of each other;
wherein the first clock and the second clock swing from a ground supply to a power supply voltage of the power supply.

9. The dual-output triple-Vdd charge pump of claim 2 wherein the first inner node is pumped by the first inner pumping capacitor to double the power supply voltage;
wherein the second inner node is pumped by the second inner pumping capacitor to double the power supply voltage;
wherein the first outer node is pumped by the first outer pumping capacitor to triple the power supply voltage minus a voltage drop through the first inner diode and minus parasitic voltage losses;
wherein the first output node has a maximum voltage of triple the power supply voltage minus a voltage drop through the first inner diode and minus a voltage drop through the first outer diode and minus parasitic voltage losses;
wherein the second outer node is pumped by the second outer pumping capacitor to triple the power supply voltage minus a voltage drop through the second inner diode and minus parasitic voltage losses;
wherein the second output node has a maximum voltage of triple the power supply voltage minus a voltage drop through the second inner diode and minus a voltage drop through the second outer diode and minus parasitic voltage losses.

10. A charge pump circuit comprising:
a first cross-coupled transistor having a source connected to a power supply, a drain connected to a first inner node, and a gate connected to a second inner node;
a second cross-coupled transistor having a source connected to the power supply, a drain connected to the second inner node, and a gate connected to the first inner node;
a first inner pumping capacitor coupled between the first inner node and a first clock;
a second inner pumping capacitor coupled between the second inner node and a second clock;
a first inner diode coupled between the first inner node and a first outer node, for allowing current to flow to the first outer node and for preventing reverse current flow to the first inner node;
a first outer pumping capacitor coupled between the first outer node and a second clock; and
a first outer diode coupled between the first outer node and a first output node, for allowing current to flow to the first output node and for preventing reverse current flow to the first outer node.

11. The charge pump circuit of claim 10 further comprising:
a second inner diode coupled between the second inner node and a second outer node, for allowing current to flow to the second outer node and for preventing reverse current flow to the second inner node;
a second outer pumping capacitor coupled between the second outer node and the first clock; and
a second outer diode coupled between the second outer node and a second output node, for allowing current to flow to the second output node and for preventing reverse current flow to the second outer node.

12. The charge pump circuit of claim 11 wherein a substrate node of the first cross-coupled transistor is connected to a ground;
wherein a substrate node of the second cross-coupled transistor is connected to a ground.

13. The charge pump circuit of claim 12 wherein the first cross-coupled transistor is an n-channel transistor;
wherein the second cross-coupled transistor is an n-channel transistor.

14. The charge pump circuit of claim 13 wherein the first inner diode comprises a p-channel transistor having a gate, a drain, and a substrate connected to the first outer node and a source connected to the first inner node;
wherein the first outer diode comprises a p-channel transistor having a gate, a drain, and a substrate connected to the first output node and a source connected to the first outer node.

15. The charge pump circuit of claim 14 wherein the second inner diode comprises a p-channel transistor having a gate, a drain, and a substrate connected to the second outer node and a source connected to the second inner node;
wherein the second outer diode comprises a p-channel transistor having a gate, a drain, and a substrate connected to the second output node and a source connected to the second outer node.

16. The charge pump circuit of claim 15 further comprising:
an inverter coupled between the first clock and the second clock;
wherein the first clock and the second clock are inverses of each other.

17. A cross-coupled charge-pump circuit comprising:
first n-channel cross-coupled transistor means, having a first gate connected to a first inner node, for conducting current from a power supply to a second inner node in response to the first gate;
second n-channel cross-coupled transistor means, having a second gate connected to the second inner node, for conducting current from the power supply to the first inner node in response to the second gate;
first inner pumping capacitive coupling means, coupled to the first inner node, for pumping a voltage of the first inner node in response to a first clock;
second inner pumping capacitive coupling means, coupled to the second inner node, for pumping a voltage of the second inner node in response to a second clock;
first inner diode means for conducting current between the first inner node and a first outer node, and for preventing back current flow from the first outer node to the first inner node;
first outer pumping capacitive coupling means, coupled to the first outer node, for pumping a voltage of the first outer node in response to the second clock; and
first outer diode means for conducting current between the first outer node and a first output node, and for preventing back current flow from the first output node to the first outer node.

18. The cross-coupled charge-pump circuit of claim 17 further comprising:
second inner diode means for conducting current between the second inner node and a second outer node, and for preventing back current flow from the second outer node to the second inner node;
second outer pumping capacitive coupling means, coupled to the second outer node, for pumping a voltage of the second outer node in response to the first clock; and
second outer diode means for conducting current between the second outer node and a second output node, and for preventing back current flow from the second output node to the second outer node,
whereby two outputs are generated.

19. The cross-coupled charge-pump circuit of claim 18 wherein the first inner diode means comprises a p-channel transistor means having a gate connected to the first outer node;
wherein the second inner diode means comprises a p-channel transistor means having a gate connected to the second outer node;
wherein the first outer diode means comprises a p-channel transistor means having a gate connected to the first output node;
wherein the second outer diode means comprises a p-channel transistor means having a gate connected to the second output node.

20. The cross-coupled charge-pump circuit of claim 19 wherein a bulk node of the first n-channel cross-coupled transistor means is grounded;
wherein a bulk node of the second n-channel cross-coupled transistor means is grounded;
wherein a substrate of the first inner diode means is connected to the first outer node;
wherein a substrate of the second inner diode means is connected to the second outer node;
wherein a substrate of the first outer diode means is connected to the first output node;
wherein a substrate of the second outer diode means is connected to the second output node.
